(19) United States
(12) Patent Application Publication
(10) Pub. No.: US 2023/0076086 A1
(43) Pub. Date: Mar. 9, 2023

(54) MANUALLY OPERATED, NONPOWERED WASTE DISPOSAL SYSTEM FOR A RECREATIONAL VEHICLE

(71) Applicants: Ryan Christopher Akin, Huntersville, NC (US); Robert Steven Hamlett, Huntersville, NC (US)

(72) Inventors: Ryan Christopher Akin, Huntersville, NC (US); Robert Steven Hamlett, Huntersville, NC (US)

(21) Appl. No.: 17/648,614

(22) Filed: Jan. 21, 2022

Related U.S. Application Data
(60) Provisional application No. 63/242,385, filed on Sep. 9, 2021.

(51) Int. Cl. B60R 15/00; F16L 27/12

(52) U.S. Cl. CPC B60R 15/00; F16L 27/125

(57) ABSTRACT

A recreational vehicle waste disposal system is provided. The waste disposal system includes a conduit assembly having a proximal end connected to the sewer outlet of a sanitation unit, wherein the distal end of the waste disposal system is rotatable relative to and extendable from the proximal end. A user may rotate the conduit assembly between an operable position and a stored position directly under the RV's sanitation unit. The downstream portion defines an extension arrangement of a plurality of threaded conduit sections that may be optionally connected to allow an extended length to store two waste hoses if desired.

### CROSS-REFERENCE TO RELATED APPLICATION

This application claims the benefit of priority of U.S. provisional application No. 63/242,385, U.S. provisional application number filed 9 Sep. 2021, the contents of which are herein incorporated by reference.

### BACKGROUND OF THE INVENTION

The present invention relates to recreational vehicles (RVs) and, more particularly, a manually operated, nonpowered waste disposal system for disposal of waste from a RV, wherein the waste disposal system has a proximal end connected to the sewer outlet of a sanitation unit of the RV, and wherein the distal end of the waste disposal system is rotatable relative to and selectively extendable from the proximal end.

RVs are synonymous with freedom, a mobile house that can roam the open roads, allowing users to explore remote parts of the country. The process of waste disposal (both sewage and gray water) that is required during this exploration is, however, laborious as it currently demands handling and assembling of various, disparate equipment and hardware as well as their disassembly and storage when travelling. The current process of connecting and operating a RV sewer hose is time-consuming and requires manual removal, assembly, and connection before each use. It also demands, subsequent use, disconnection, disassembly and storage after each use. The current capability to store RV sewer hoses is a separate process that is inconvenient, cumbersome as well as requiring storage space and valuable time to setup before use and breakdown and storage after use.

As can be seen, there is a need for a manually operated, nonpowered waste disposal system for disposal of waste from a RV to eliminate the current need to perform the cumbersome and time-consuming steps of removing, assembling, connecting, and restoring a sewage drain hose for RVs. The present invention embodies a multi-purpose and systemic device that attaches to an RV's sewage disposal outlet and engages the RV's sewage drain hose, thereby enabling its rotation and selective linear positioning and repositioning during use and thereafter. By way of the systemic device, the RV's sewage drain hose can maintain a constant stored position and be selectively expandable for its positioning and repositioning during and after use, without having to disconnect or reconnect the sewage drain hose to and from the RV, or even directly handle the flexible sewage drain hose, that can be unwieldy.

As a result, the present invention simplifies the RV waste tank drainage process through installing an efficient, nonpowered connection and rotational conduit system that safely stores the flexible sewage drain hose(s) during nonuse and transport, and thereby eliminates the laborious need to disconnect and store the hose after each use.

### SUMMARY OF THE INVENTION

In one aspect of the present invention, a waste disposal system for a recreation vehicle with an external sewage outlet includes: a conduit assembly extending from an upstream portion and a downstream portion; the upstream and downstream portions define a bearing connection, wherein the downstream portion is rotatable relative the upstream portion; and the downstream portion defines a telescopic arrangement of a plurality of conduits, wherein the telescopic arrangement is movable between an extended position and a nest position.

In another aspect of the present invention, the waste disposal system includes upstream portion having a proximal end connected to the RV's external sewage outlet, wherein the proximal end connector has an access opening operatively associated with a clamp bridging at the proximal-most end of the access opening to provide a secure connection as well as access to the waste hose connection point. The bearing connection comprises two interfacing flange portions, each flange portion having a radial connection slot and one or more flange holes radially spaced apart thereto, wherein the radial connection slot concentrically aligns with the one or more flange holes of the interfacing flange portion. Each of the plurality of conduits have a linear connection slot and a conduit hole equally spaced apart.

In yet another aspect of the present invention, a waste disposal system for a recreation vehicle with an external sewage outlet provides the following: a conduit assembly extending from an upstream portion and a downstream portion; the upstream and downstream portions define a bearing connection enabling the downstream portion to be rotatable relative the upstream portion; the downstream portion is movable between an extended position and a contracted position; and the downstream portion defines an extension arrangement of a plurality of threaded conduit sections configured to store two waste hoses in the extended condition. These and other features, aspects and advantages of the present invention will become better understood with reference to the following drawings, description and claims.

### BRIEF DESCRIPTION OF THE DRAWINGS

FIG. 1 is a side elevation view of an exemplary embodiment of the present invention.

FIG. 2 is a detailed bottom perspective view of an exemplary embodiment of the present invention.

FIG. 3 is an exploded bottom perspective view of an exemplary embodiment of the present invention.

FIG. 4 is a typical cross-sectional view of an exemplary embodiment of the present invention, shown in a stored position.

FIG. 5A is a cross-sectional view of an exemplary embodiment of the present invention, taken along line 5A-5A in FIG. 4.

FIG. 5B is a cross-sectional view similar to 5A, rotated 90 degrees.

FIG. 6 is a typical cross-sectional view of an exemplary embodiment of the present invention, shown in an extended position.

FIG. 7 is an exploded detailed perspective view of an exemplary embodiment of the present invention.

FIG. 8 is a side elevation view of an exemplary embodiment of the present invention.

FIG. 9 is a perspective view of an exemplary embodiment of the present invention.

FIG. 10 is a typical cross-sectional view of an exemplary embodiment of the present invention, shown in a stored position.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a recreational vehicle (RV) waste disposal system, wherein the waste disposal system has a proximal end connected to the sewer outlet of the RV's sanitation unit, and wherein the distal end of the waste disposal system is rotatable relative to and extendable from the proximal end.

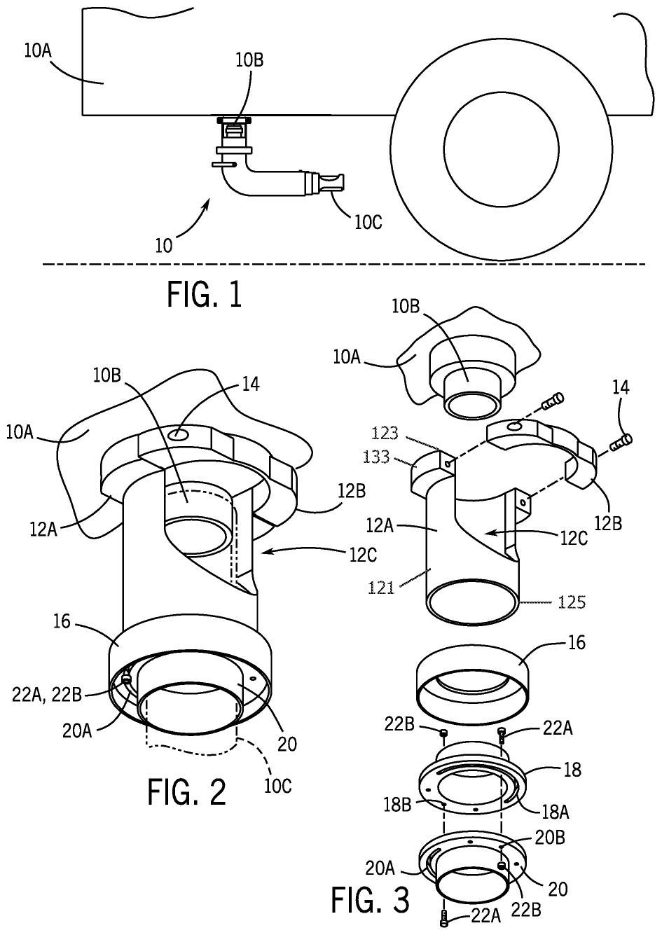

Referring now to FIGS. 1 through 3, the present invention may include a waste disposal system 10. The waste disposal system 10 may be designed for a sanitation system 10A having an external sewer connection 10B or sewage outlet connectable with a sewage conduit 10C. The sanitation system 10A may be associated with a stationary or mobile structure, such as a recreational vehicle.

The disposal system 10 may include a partial open holder 12A. The partial open holder 12A may have a conduit portion 121 that extends from a proximal end 123 to a distal end 125. The proximal end 123 may include a partial flange 133. An access opening 12C may be formed in the conduit portion 121, wherein the access opening 12C communicates to the proximal end 123, defining the bounds of the partial flange 133. Accordingly, the access opening 12C allows for access to the sewer connection 10B through the conduit portion 121. A holder clamp 12B may be dimensioned to interconnect the opposing bounds of the partial flange 133, as illustrated in FIG. 3, and thereby fasten to the sewer connection 10B when fasteners 14 connect ends of the holder clamp 12B to complementary ends of the partial flange 133.

In certain embodiments, a first bearing ring 18 having an upper cylindrical portion slides into the distal end 125, wherein the first bearing ring 18 provides a first flange portion with a first radial connection slot 18A and connection holes 18B radially spaced apart between opposing ends of the first radial connection slot 18A.

A second bearing ring 20 having a second cylindrical portion that extends away from the distal end 125, wherein the second bearing ring 20 provides a second flange portion with a second radial connection slot 20A and holes 20B radially spaced apart between opposing ends of the second radial connection slot 20A.

The first and second flanges portions abut and are connected through their respective radial connection slots 18A and 20A by way of pins 22A and complementary connectors 22B. A cap 16 may be dimensioned and adapted to collar the distal end 125 while shielding the first and second flanges portions.

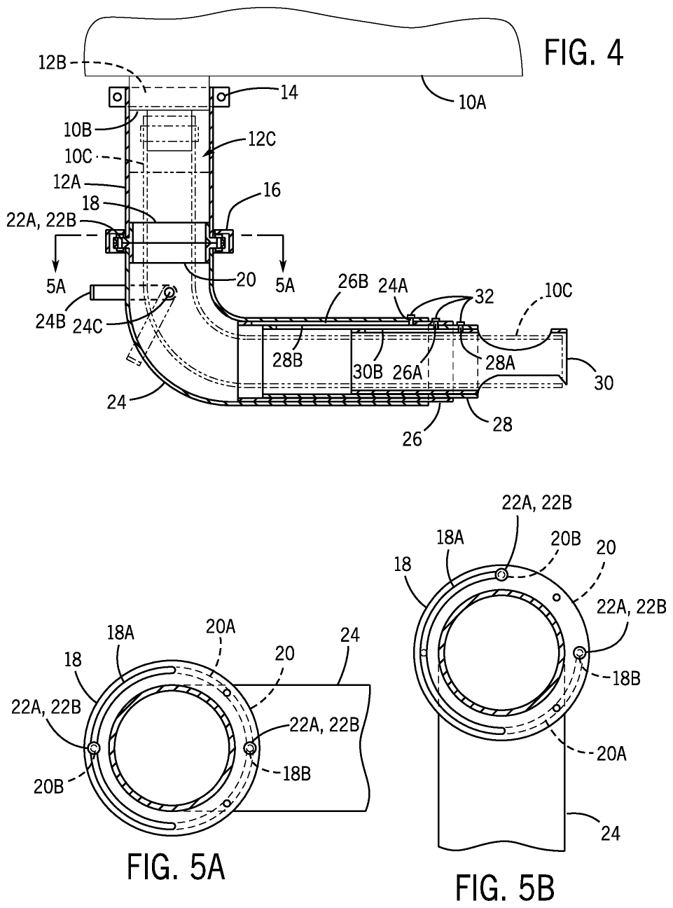

Referring to FIGS. 4 through 5B, a downstream conduit 24 may slide its proximal end into or over the second cylindrical portion. The downstream conduit 24 may have a handle 24A that is pivotable about a pivot point 12C. The downstream conduit 24 may be one or various conduit types and associated fittings, including but not limited to an elbow section.

The bearing point defined by the interfacing first and second flanges portions allowing for rotation of the downstream conduit 24 without movement to the holder 12A, through the pins 22A riding along the respective radial connection slots 18A and 20A, as illustrated in FIGS. 5A and 5B. As a result, the downstream conduit 24 rotates about a longitudinal axis of the holder 12A.

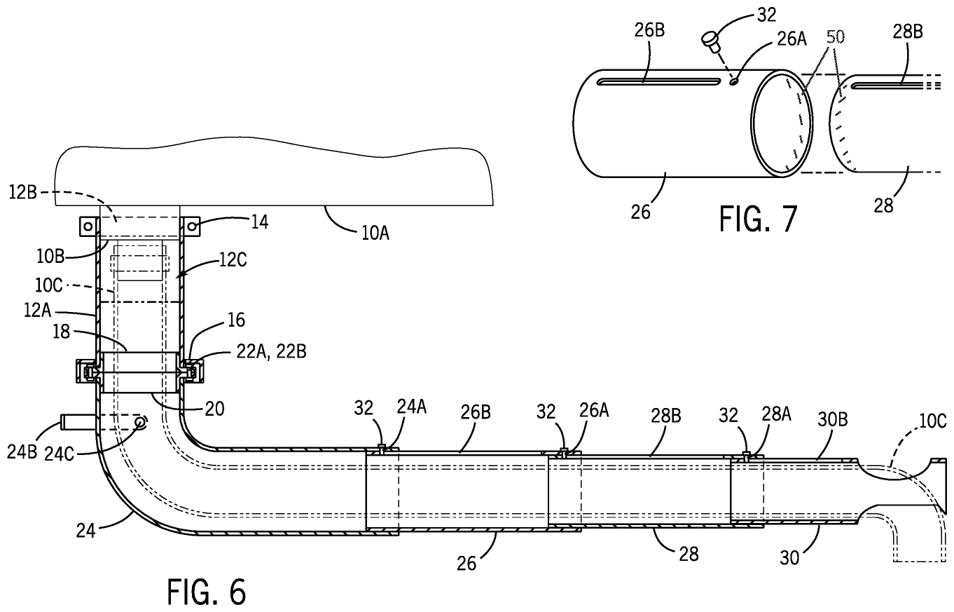

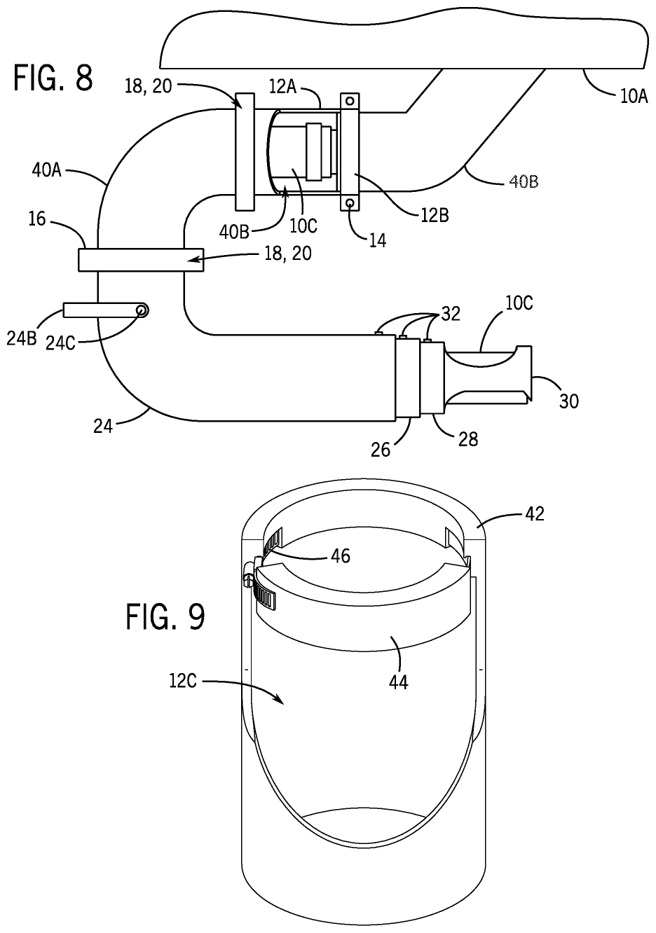

Referring to FIGS. 6 through 7, one or more linear conduits 26, 28, 30, each providing a linear connection slot 26B, 28B, 30B, respectively, spaced apart from a respective connection hole 26A, 28A, 30A. The connection slot of one conduit may engage the connection hole of an adjacent conduit by way of a guide pin 32. As a result, the present invention enables selective interconnectivity between the two adjacent, operatively associated conduits, whereby the length that one conduit protruded from its operatively associated adjacent conduit can be selected by the user. Thereby, facilitating moving the disposal system 10 between the extended position (FIG. 6) or a storage position (FIG. 8). As a result, the linear conduits 26, 28, 30 can be sequentially connected and be in either the extended position or the storage position, whichever suits the user. Conceptually, this selectivity enables a telescopic or collapsible functionality between the one or more linear conduits 26, 28, 30.

Alternatively, the one or more linear conduits 26, 28, 30 may have complementary threading 50 (e.g., male and female), as illustrated in FIG. 7, for interconnecting adjacent conduits.

Referring to FIGS. 8 through 9, the linear conduit 30 may have an access opening 12C to enable access to the sewage conduit 10C extending from the sewer connection 10B to the distal-most linear conduit 30. The access opening 12C may communicate to the distal end 42. A collar portion 44 may bridge the bounds of the distal end 42 defined by the access opening 12C, as illustrated in FIG. 9. Connectors 46 may facilitate a removable connection between the collar portion 44 and the distal end 42. In certain embodiments, other fittings 40A may be used to define the path of the sewage conduit 10C, as illustrated in FIG. 8.

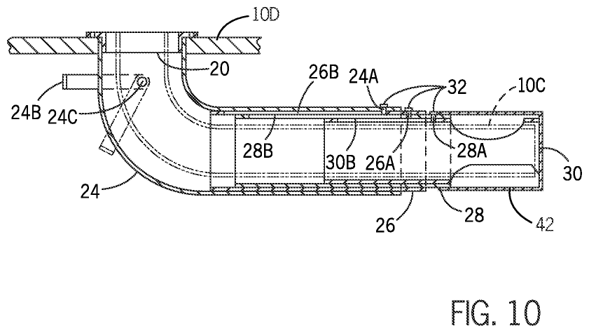

Referring to FIG. 10, in other embodiments the lower conduit 24 connects directly to the sanitation compartment floor 10D of the sanitation system 10A.

A method installing the waste disposal system 10 disclosed above may include the following. The holder clamp 12B facilitates joining the holder 12A to the to the main sewer connection 10B outlet, wherein the holder 12A has a partial access opening 12C to allow access to the sewer connection 10B and sewage conduit 10A. Bearing assisted connectors 18 and 20 may interconnect an upstream conduit and the downstream conduit 24, allowing for independent movement of the downstream conduit 24. The handle 24A may be attached thereto allowing for easy rotation of the downstream conduit 24. A linear connection slot with a stopping pin may be manufactured at the end of the downstream conduit 24. A plurality of conduit sections 26, 28, and 30 may each have a similar linear connection slot (“lips”) and stopper. The distal-most collapsible conduit 30 has an access opening 12C to a handle the sewage conduit 10A.

The waste disposal system 10 connects directly to the RV's sewer outlet with an easy-to-use handle for rotating of the storage device from an in-use position to a stored position under the recreational vehicle when traveling, where a user can set the appropriate stops for the storage/travel position and the extended/operational positions. Then the user connects the sewer hose to the sanitation unit and places the hose within the device, however it is configured. When needing to dump the waste, the handle allows the user to rotate and extend the hose to the correct distance for the dumping of waste. When complete, the user may rotate the device and store it back under the vehicle for travel.

As used in this application, the term “about” or “approximately” refers to a range of values within plus or minus 10% of the specified number. And the term “substantially” refers to up to 90% or more of an entirety. Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A waste disposal system for a recreation vehicle with an external sewage outlet, the system comprising:
a conduit assembly extending from an upstream portion and a downstream portion;
the upstream and downstream portions define a bearing connection, wherein the downstream portion is rotatable relative the upstream portion; and
the downstream portion defines a telescopic arrangement of a plurality of conduits, wherein the telescopic arrangement is movable between an extended position and a nest position.

2. The system of claim 1, wherein the upstream portion has a proximal end connected to the external sewage outlet, and wherein the proximal end has an access opening.

3. The system of claim 2, further comprising a clamp bridging a proximal-most end of the access opening.

4. The system of claim 1, wherein the bearing connection comprises two interfacing flange portions, each flange portion having a radial connection slot and one or more flange holes radially spaced apart thereto.

5. The system of claim 4, wherein the radial connection slot concentrically align with the one or more flange holes of the interfacing flange portion.

6. The system of claim 5, wherein each of the plurality of conduits has a linear connection slot and a conduit hole linearly spaced apart therefrom.

7. The system of claim 6, wherein the downstream portion provides linear connection slot.

8. The system of claim 7, wherein a distal-most conduit of the plurality of conduits has an access opening.

9. The system of claim 8, wherein the upstream portion has a proximal end connected to the external sewage outlet, and wherein the proximal end has an access opening.

10. The system of claim 9, further comprising a clamp bridging the proximal-most end of the access opening.

11. A waste disposal system for a recreation vehicle with an external sewage outlet, the system comprising:
a conduit assembly extending from an upstream portion and a downstream portion;
the upstream and downstream portions define a bearing connection enabling the downstream portion to be rotatable relative the upstream portion;
the downstream portion is movable between an extended position and a contracted position; and
the downstream portion defines an extension arrangement of a plurality of threaded conduit sections configured to store two waste hoses in the extended condition.
